(19) United States
(12) Patent Application Publication
(10) Pub. No.: US 2013/0094333 A1
(43) Pub. Date: Apr. 18, 2013

(54) TIMEPIECE DISPLAY PLATE

(71) Applicants: Nobuo Ito, Ota-ku (JP); Takayuki Waseda, Kawaguchi-shi (JP); Shinichi Sakamaki, Sayama-shi (JP); Hiroshi Ikebuchi, Itabashi-ku (JP); Yutaka Sugihara, Itabashi-ku (JP); Shigeo Kaneko, Itabashi-ku (JP)

(72) Inventors: Nobuo Ito, Ota-ku (JP); Takayuki Waseda, Kawaguchi-shi (JP); Shinichi Sakamaki, Sayama-shi (JP); Hiroshi Ikebuchi, Itabashi-ku (JP); Yutaka Sugihara, Itabashi-ku (JP); Shigeo Kaneko, Itabashi-ku (JP)

(73) Assignees: CITIZEN HOLDINGS CO., LTD., Tokyo (JP); YAMAMOTO MANUFACTURING CO., LTD., Tokyo (JP); CITIZEN WATCH CO., LTD., Tokyo (JP)

(21) Appl. No.: 13/806,521

(22) PCT Filed: Jun. 23, 2011
(86) PCT No.: PCT/JP2011/064456

§ 371 Date: Dec. 21, 2012

(30) Foreign Application Priority Data
Jun. 23, 2010 (JP) 2010-142503

(51) Int. Cl. G04B 19/06

(52) U.S. Cl. CPC G04B 19/06
USPC 368/239

(57) ABSTRACT

A timepiece display plate, while obtaining reflection light having metal texture, allows partial light as a transmissive light to transmit to a solar cell and easily adapt to various types of dial plates. A timepiece display plate (150) for a timepiece (200) having a plate-like solar cell (130), includes a light transmissive dial plate (151) and a brightness improving film (brightness improving plate) separately disposed between the light transmissive dial plate (151) and the solar cell (130).

### TECHNICAL FIELD

The present invention relates to a timepiece display plate, and particularly, relates to an improvement of a display plate for a timepiece having a solar cell.

### BACKGROUND ART

Conventionally, a timepiece having a solar cell converting energy of received light into electricity has been put to practical use, in which electromotive force is used as a power source.

The solar cell is, for example, in a portable timepiece, disposed at a back side of a dial plate where time characters and the like are indicated, which is opposite to a side facing a glass, due to space layout and the like.

In order to generate electricity, it is necessary to receive energy of light and certain amount of light reaching the back side of the dial plate is necessary. Therefore, the dial plate has light permeability, and is transparent, translucent, or the like.

Material having light permeability among materials generally used to form a dial plate includes glass, plastic (resin), ceramics and the like. However, in case where simply transparent or translucent material is used, light reflected on a solar cell, that is, deep violet color which is inherent in the solar cell is visually recognized through the dial plate by an observer. Therefore, the color of the solar cell (deep violet) is overlapped with color of the dial plate itself so that dark color is visually recognized as the color of the dial plate by the observer. Thereby, visibility of time characters and the like indicated on the dial plate is degraded or less appearance (appearance quality) is caused.

On the other hand, as a dial plate for a timepiece, material having a texture of metal such as gold, silver or platinum (depending on luster or color) has an advantage in terms of appearance. However, since a dial plate made of metal material does not have light permeability and therefore energy of light cannot be supplied to the solar cell, the dial plate made of metal material cannot be used in a timepiece using a solar cell.

Accordingly, a dial plate is required, which keeps light reflected on a solar cell from transmitting a back side while having light permeability. As such a dial plate, a dial plate has been proposed, which has a transmissive dial plate having a lower surface (surface facing a solar cell) on which a number of prism surfaces are formed and a semi-transmissive reflection plate provided on a side of the lower surface (see Patent document 1).

According to the dial plate, a part of light entering an upper surface of the transimissive dial plate is reflected on the lower surface and a part of the light entering the upper surface of the transmissive dial plate passes through the lower surface and reaches the semi-transmissive reflection plate. Since the lower surface of the transmissive dial plate has prism surfaces, a larger amount of light reflected on the prism surfaces is obtained than that of light reflected on a conventional simply flat-formed lower surface. Furthermore, since a part of light passing through the prism surfaces of the lower surface is also reflected on the semi-transmissive reflection plate, the dial plate can be visually recognized as a bright dial plate by the observer viewing the dial pate from an upper surface side of the transmissive dial plate.

In addition, light passing through the semi- transmissive reflection plate, reaching the solar cell, reflected on the solar cell, and then directed toward the transmissive dial plate is partially reflected on the prism surfaces formed on the lower surface of the transmissive dial plate. Therefore, among the light reflected on the solar cell, an amount of light visually recognized by the observer viewing through the upper surface of the transmissive dial plate is remarkably reduced compared to the conventional one. As a result, appearance quality of the dial plate can be further improved.

Furthermore, the reflection on the prism surfaces causes a texture analogous to specular reflection as light of total reflection and therefore shows a metal texture.

Furthermore, it has been proposed that a light guiding means is provided between a transmissive dial plate and a solar cell (Patent document 2).

Such a timepiece 1 with a solar cell includes an exterior case 11, a display panel 20 disposed in the exterior case 11, a solar cell 30 disposed on a back side of the display panel 20, and a light guiding means 40, as a basic configuration. The light guiding means 40 includes a light taking part 411 to take light without the aid of the display panel 20 and a light guide part 412 to guide light continuously constituted and taken in the light taking part 411 toward the back side of the display panel 20 and to irradiate an electricity generating surface of the solar cell 30 with the light.

Since it is not necessary for the display panel 20 to have light permeability, kinds of material or the like used for the display panel are not restricted.

This has a structure in that, from a cover glass side, a display panel, a solar cell (solar substrate and a solar cell), and a diffusion part (a prism sheet and a diffusion sheet) are disposed in the light guide plate having a concave portion at a center, and light is taken from the light taking part provided on a circumferential part of the light guide plate so that light is guided to the solar cell. Therefore, the solar cell 30 can be completely covered over by the display panel 20, and thereby the solar cell is not viewed through from the cover glass side and design can be improved.

### PRIOR ART DOCUMENTS

### Patent Documents

Patent Document 1: Japanese Patent Application Publication No. 2007-3356.

Patent Document 2: Japanese Patent Application Publication No. 2008-209368.

### SUMMARY OF THE INVENTION

### Problem to be Solved by the Invention

Since a dial plate is a feature of an appearance of a timepiece, a dial plate is required to be prepared in various types so as to be adapted depending on a line of products or an object of users.

In case of technology shown in the above patent document 1, decorative finishing can be made on the upper surface by printing or painting. However, if decorative finishing is made on the lower surface, prism effects cannot be easily obtained and light transmitting from the prism surfaces downwardly (toward the solar cell) is reduced. Accordingly, due to reasons, such as a reason that functions of the semi-transmissive reflection plate positioned under the transmissive dial plate cannot be effectively obtained, and the like, it is difficult to provide decorative finishing on the prism surfaces. Accordingly, design variation of the transmissive dial plate cannot be expanded.

Further, it is necessary to install time characters or letters such as composition on the upper surface of the transmissive dial plate having the lower surface where the prism surfaces are previously formed. However, in the process of installing time characters or letters, the prism surfaces of the lower surface can be easily damaged.

That is, there is a case where a small hole is formed in the transmissive dial plate to install a leg portion provided on a lower surface of the composition (time characters, logos, and the like). The small hole is formed by a die punch provided on a pressing machine. In forming the small hole, the die punch penetrates the prism surface of the lower surface of the transmissive dial plate and in addition, high pressure is applied to a top (ridge portion or top portion) of a prism and therefore the top of the prism is crashed and the prism surface is damaged.

The composition is fixed on the transmissive dial plate by inserting a leg portion into a small hole, swaging a tip of the leg portion from a side of the lower surface to prevent the leg portion from detaching from the small hole. However, in the swaging process of the tip of the leg portion, prism surfaces can be easily damaged. Therefore, careful operation is required and it is difficult to improve workability.

When prism surfaces of the lower surface is damaged, reflection does not appropriately occur at the damaged part. Thereby, an amount of light reflected to an observer is reduced and appearance quality is degraded, for example, dark part is locally viewed.

On the other hand, in case of the technology shown in Patent document 2, there are the following problems (1) to (3). (1) Since a light guide plate and a light shielding plate are required and therefore thickness of a display part increases and, as a result, a timepiece with a solar cell becomes thick, it is difficult to be applied to a dress watch or a timepiece for woman (small size). (2) Due to the structure which guides light entering the upper surface of the light guide plate toward the solar cell via the reflection plate and the diffusion part, the structure itself is complicated, light is remarkably attenuated and light is not effectively used (large amount of light does not reach the solar cell). (3) Since the diffusion part (prism sheet and diffusion sheet) abutting on the solar cell has a configuration in that the prism sheet and the diffusion sheet are separately or integrally provided, the structure is complicated and it is hard to be dealt with. Especially, if there are damages and dirt on the prism sheet, light collecting function of the diffusion part is remarkably degraded. Furthermore, since the diffusion part abuts on the solar cell, the solar cell and the top of the prism sheet can easily get damages.

The present invention is made to address the above conditions, and is directed to provide a timepiece display plate easily adapted to a variety of dial plates while obtaining reflection light having a metal texture with a simple structure and allowing a part of light to transmit to the solar cell as transmissive light.

### Means for Solving the Problem

A timepiece display plate according to the present invention is a timepiece display plate used in a timepiece with a plate-like solar cell and includes a light transmissive dial plate, a brightness improving plate disposed between the light transmissive dial plate and the solar cell.

The brightness improving plate is a tabular plate, a film, a sheet, or the like and has a function of increasing an amount of reflection light entering the brightness improving plate. For example, the tabular plate has one surface formed in a flat surface and the other surface formed in a convexo-concave surface such as prism surfaces and the like can be applied.

Such a convexo-concave surface such as prism surfaces and the like of the brightness improving plate is to increase an amount of reflection light compared to a flat surface, and therefore when viewed from a side of an incident surface of the brightness improving plate, improved brightness is visually recognized.

The convexo-concave surface such as the prism surfaces and the like formed on the brightness improving plate may be formed to extend along one direction in a plate plane of the brightness improving plate (in groove forms extending along one direction) and may be formed to extend along two directions perpendicular to each other in a regular or random arrangement in a geometric pattern (for example, four-sided pyramid, four-sided pyramid-like concave shape having a convex/concave inverse shape of the above four-sided pyramid, three-sided pyramid, three-sided pyramid-like concave shape having a convex/concave inverse shape of the above three-sided pyramid, semispherical dome-like shape, dome-like concave shape having a convex/concave inverse shape of the above dome like shape, and the like are regularly arranged in a matrix with closely-attached or adjacent bases to each other).

According to such a timepiece display plate according to the present invention configured as mentioned above, light, which the timepiece display plate is irradiated with from outside, first enters the light transmissive dial plate, a part of the entering light passes through the light transmissive dial plate in accordance with light transmissive property of the light transmissive dial plate, and then the passing light enters the brightness improving plate.

The brightness improving plate increases an amount of reflection light entering the brightness improving plate by the above-mentioned reflection light amount increasing function, and the reflection light whose light amount is increased returns to the light transmissive dial plate and thereby the light transmissive dial plate is irradiated from a back side. The reflection light with which the light transmissive dial plate is irradiated from the back side passes through the light transmissive dial plate and outputs toward a side where the timepiece display plate has been irradiated. Since the reflection light amount is increased, the brightness of the light transmissive dial plate can be improved.

The reflection on the convexo-concave surface such as the prism surfaces of the brightness improving plate has a texture analogous to specular reflection as light of total reflection, and therefore shows a metal texture.

On the other hand, a part of light passing through the light transmissive dial plate and entering the brightness improving plate passes through the brightness improving plate and reaches the solar cell disposed at a back side of the brightness improving plate and thereby electromotive force from the solar cell can be obtained.

Since a part of the reaching light is reflected on a surface of the solar cell, reflection light having deep violet color according to substance forming the surface of the solar cell is reflected to the brightness improving plate. In the reflection light on the solar cell, a light amount reflected in a direction returning to the solar cell by the brightness improving plate is increased and a light amount (transmissive light amount) in a direction passing through the brightness improving plate (directed toward the light transmissive dial plate) is decreased.

Then, due to combination between the fact that light having deep violet color from the solar cell and output from the timepiece display plate (light reflected on the solar cell, passing through the brightness improving plate, and passing the light transmissive dial plate) is reduced and the fact that reflection light reflected on the brightness improving plate and having a metal texture is increased, the timepiece display plate can achieve a brighter plate surface of the light transmissive dial plate with simple structures.

According to a timepiece display plate according to the present invention, a dial plate on which time characters, letters and decoration such as composition are provided, and which is considered as a face of a timepiece is provided physically separately from a brightness improving plate which improves brightness, as individual elements. Therefore, the light transmissive dial plate can be formed with the brightness improving plate separated, and damages by various processes on the light transmissive dial plate, such as composition (time characters, letters), cutting, printing logos, and the like, can be prevented on a part (for example, prism surface and the like) having a role to improve brightness of the brightness improving plate.

Since decorative finishing by printing or painting can be made on a back surface (lower surface) of the light transmissive dial plate, design variation can be expanded.

Accordingly, processing methods of the light transmissive dial plate are not restricted in relation to the brightness improving plate and therefore various types of dial plates can be provided by using various decorative expressions and process methods.

According to a timepiece having a plate-like solar cell and the above mentioned timepiece display plate according to the present invention, a part of light passes the solar cell as transmissive light while obtaining reflection light having a metal texture with non-metal material with simple structures, and it is possible to easily adapt to various dial plate.

### Effect of the Invention

According to a timepiece display plate of the present invention, it is possible to allow a part of light to transmit to the solar cell as transmissive light while obtaining reflection light having a metal texture with non-metal material with simple structures, and it is possible to easily adapt to various dial plate.

Non-metal timepiece display plate can transmit radio waves and therefore is preferably applied to a solar timepiece (timepiece with a solar cell) with a radio-wave correcting function which automatically adjusts time and the like with receiving radio waves.

### BRIEF DESCRIPTION OF DRAWINGS

FIG. 1 An external view showing an embodiment of the present invention.

FIG. 2 A section view showing an arrangement of a timepiece display plate and a solar cell in the timepiece shown in FIG. 1.

FIG. 3A A perspective view viewed from an obliquely downward side over prism surfaces formed on a back surface of a brightness improving film.

FIG. 3B A schematic view explaining reflection of light on the prism surfaces.

FIG. 4 A section view showing a modified example (modified example 1) of the embodiment shown in FIG. 2, where the prism surfaces are directed to a side of a light transmissive dial plate.

FIG. 5A A perspective view showing a modified example (modified example 2) of the embodiment shown in FIG. 2, where the brightness improving film on which the prism surfaces are regularly arranged in a grid manner in two directions perpendicular to each other is viewed from an obliquely downward side.

FIG. 5B A perspective view of a brightness improving film having a convexo-concave surface obtained by inversing convexity and concavity of the convexo-concave surface of FIG. 5A, viewed from an obliquely downward side in the same way as FIG. 5A.

FIG. 6A A section view showing a modified example (modified example 3) of the embodiment shown in FIG. 2, where prism surfaces of a first brightness improving film are directed to the solar cell and prism surfaces of a second brightness improving film are directed to the light transmissive dial plate.

FIG. 6B A section view showing a modified example (modified example 3) of the embodiment shown in FIG. 2, where the prism surfaces of the first brightness improving film are directed to the light transmissive dial plate and the prism surfaces of the second brightness improving film are directed to the light transmissive dial plate.

FIG. 6C A section view showing a modified example (modified example 3) of the embodiment shown in FIG. 2, where the prism surfaces of the first brightness improving film are directed to the solar cell and the prism surfaces of the second brightness improving film are directed to the solar cell.

FIG. 6D A section view showing a modified example (modified example 3) of the embodiment shown in FIG. 2, where the prism surfaces of the first brightness improving film are directed to the light transmissive dial plate and the prism surfaces of the second brightness improving film are directed to the solar cell.

FIG. 7A A section view showing a modified example (modified example 4) of the embodiment shown in FIG. 2, where the prism surfaces of the first brightness improving film are directed to the solar cell and the prism surfaces of the second brightness improving film are directed to the light transmissive dial plate.

FIG. 7B A section view showing a modified example (modified example 4) of the embodiment shown in FIG. 2, where the prism surfaces of the first brightness improving film are directed to the light transmissive dial plate and the prism surfaces of the second brightness improving film are directed to the light transmissive dial plate.

FIG. 7C A section view showing a modified example (modified example 4) of the embodiment shown in FIG. 2, where the prism surfaces of the first brightness improving film are directed to the solar cell and the prism surfaces of the second brightness improving film are directed to the solar cell.

FIG. 7D A section view showing a modified example (modified example 4) of the embodiment shown in FIG. 2, where the prism surfaces of the first brightness improving film are directed to the light transmissive dial plate and the prism surfaces of the second brightness improving film are directed to the solar cell.

FIG. 8A A section view showing a modified example (modified example of modified example 4) of the embodiment shown in FIG. 7B.

FIG. 8B A section view showing a modified example (modified example of modified example 1) of the embodiment shown in FIG. 4.

FIG. 9A A section view showing a modified example (modified example 5) of the embodiment shown in FIG. 2, where the prism surfaces are directed to the solar cell.

FIG. 9B A section view showing a modified example (modified example 5) of the embodiment shown in FIG. 2, where the prism surfaces are directed to the light transmissive dial plate.

FIG. 10A A section view showing a modified example (modified example 6) of the embodiment shown in FIG. 2, where the prism surfaces are directed to the solar cell.

FIG. 10B A section view showing a modified example (modified example 6) of the embodiment shown in FIG. 2, where the prism surfaces are directed to the light transmissive dial plate.

FIG. 10C A section view showing a modified example (modified example 6) of the embodiment shown in FIG. 2, where a decorative layer is added to the configuration shown in FIG. 10A.

### MODE FOR CARRYING OUT THE INVENTION

Hereinafter, specific embodiments of a timepiece display plate according to the present invention and a timepiece using the same will be explained with reference to drawings.

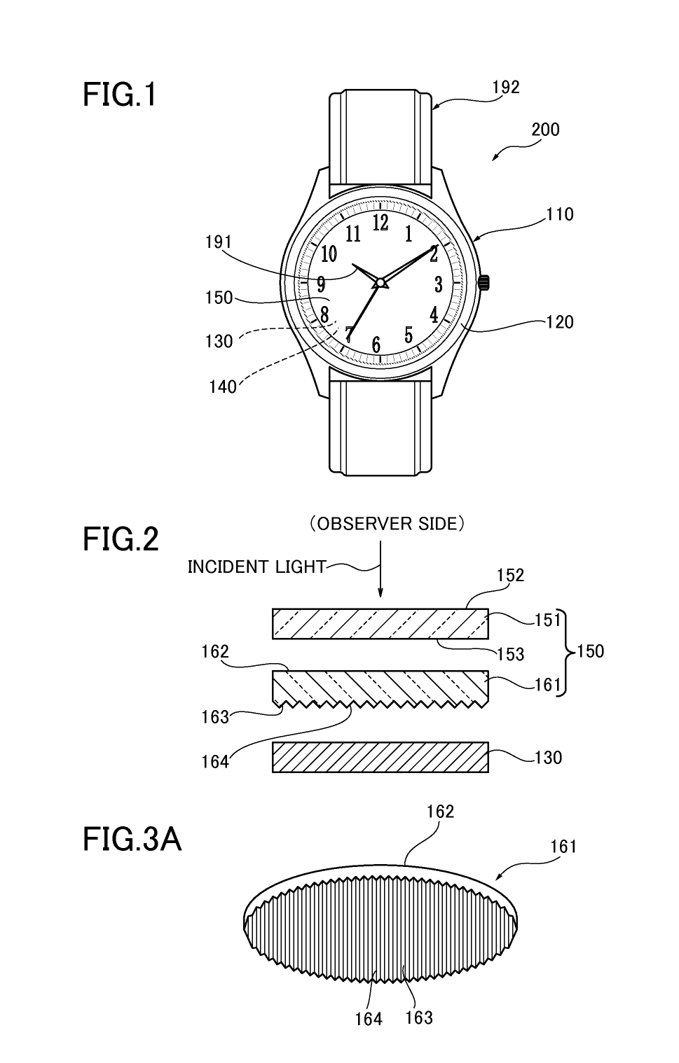

FIG. 1 is an external view showing a timepiece 200 (for example, portable timepiece) using a timepiece display plate of an embodiment of the present invention.

The illustrated timepiece 200 includes a timepiece main body 110 and a timepiece band 192 for attaching and detaching the timepiece main body 110 to a user arm. The timepiece main body includes a metal case 120, a movement 140 which is a mechanism to drive indicators 191 such as an hour hand, a minute hand, and a second hand, a solar cell 130 provided as a power for the movement 140, and a timepiece display plate 150 provided between the indicators 191 and the solar cell 130.

The solar cell 130 is formed in a flat plate form along a plane of the sheet of FIG. 1 and the timepiece display plate 150 covers the solar cell 130.

In case an amount of light entering the timepiece display plate 150 is 100%, when an amount of light entering the solar cell 130 is 10% or more, the solar cell 130 generates electricity and the generated electricity gives energy enough to drive the timepiece 200

The timepiece display plate 150 has, as shown by a section view in FIG. 2, a light transimissive dial plate 151 and a brightness improving film 161 (as an example of a brightness improving plate) provided between the light transmissive dial plate 151 and the solar cell 130 separately therefrom.

The light transmissive dial plate 151 has a surface of a front surface 152, on which a compositions (time characters, letters) corresponding to clock time, a brand name, logos, other decorative and the like are formed by printing, swaging, carving and the like, and has an optical property (transparent or translucent) transmitting light having visible wavelengths.

While the light transmissive dial plate 151 is made of polycarbonate resin, the material is not limited to the polycarbonate resin, and other resin can be used. Material other than resin, for example, glass, sapphire, ceramics can also be used.

The brightness improving film 161 is made of resin having high transparency for visible light wavelength (for example, polyester resin, acrylic resin, and the like) and has a convexo-concave surface, which is formed on one side (in FIG. 2, a surface 163 directed toward the solar cell 130, hereinafter, referred to as a back surface 163) and on which a number of prism surfaces 164 are formed.

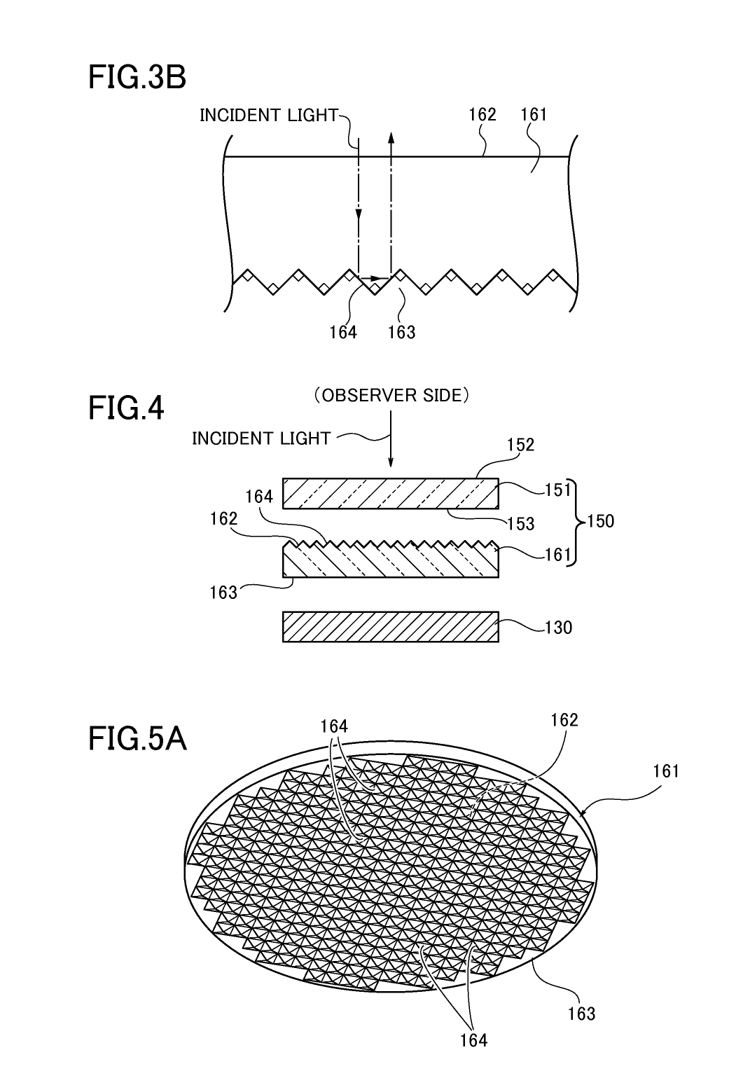

In the brightness improving film 161, the prism surfaces 164 are, as shown by a perspective view in FIG. 3A, formed in groove forms extending along one direction in the back surface 163 (in a plate plane).

The prism surfaces 164 may be formed to extend in spiral form or concentric circle form, other than ones extending along one direction as illustrated.

The prism surfaces 164 are formed with a right apex angle (90 degrees), for example, as shown in FIG. 3B and with right angles (90 degrees) formed by adjacent prism surfaces 164.

As a result, light orthogonally entering (with an incident angle of 0 degree) a front surface 162 of the brightness improving film 161 from outside of the light transmissive dial plate 151 (a glass side of the timepiece 200) is totally reflected on two prims surfaces 164 and returns the front surface 162 which the light has entered.

A large part of the light entering the front surface 162 of the brightness improving film 161 with angles other than the right angle is totally reflected on two prism surfaces 164 and returns the front surface which it has entered. A part of light entering the front surface 162 of the brightness improving film 161 with a large incident angle is refracted on a prism surface 164 and output from the back surface 163 (transmitted through the brightness improving film 161) and reaches the solar cell 130.

As mentioned above, the light illuminated on the light transmissive dial plate 151 from outside first enters the light transmissive dial plate 151, a part of the entering light passes through the light transmissive plate 151 in accordance with light transmissive characteristic of the light transmissive dial plate 151, and then the passing light enters the brightness improving film 161.

The brightness improving film 161 increases a light amount of reflection light with respect to incident light by the reflection on the prism surfaces 164, and the reflection light having the increased light amount returns the light transmissive dial plate. Thereby, the light transmissive dial plate 151 is irradiated from a side of the back surface 153 and the reflection light with which the light transmissive dial plate 151 is irradiated from the side of the back surface 153 passes through the light transmissive dial plate 151 and is output from the side of the light transmissive dial plate 151, which has been irradiated via the front surface 152. Since the reflection light amount is increased, the brightness of the light transmissive dial plate 151 can be increased.

The reflection on the prism surfaces 164 of the brightness improving film 161 has a texture analogous to specular reflection as total reflection light and therefore shows a metal texture (such as luster or color).

On the other hand, the light reaching the solar cell 130 (transmissive light), as electricity by photovoltaic effect of the solar cell 130 drives the movement 140. By the drive of movement 140, the indicators 191 and the like are driven.

The transmissive light reaching the solar cell 130 is partially reflected on the surface of the solar cell 130 and therefore reflection light having deep violet color in accordance with substance forming the surface of the solar cell 130 is reflected toward the brightness improving film 161. In the reflection light from the solar cell 130, an amount of light reflected in a direction returning to the solar cell 130 by the prism surfaces 164 formed on the back surface 163 of the brightness improving film 161 is increased and an amount of light (transmissive light amount) in a direction passing through the brightness improving film 161 (in a direction toward the light transmissive dial plate 151) is decreased.

As mentioned above, according to the timepiece display plate 150 of the present embodiment, deep violet light from the solar cell 130 (light reflected on the solar cell, passing through the brightness improving film 161, and then passing through the light transmissive dial plate 151), which is light output toward outside (user) from the timepiece display plate 150 is reduced. Furthermore, the reflection light having a metal texture by the reflection on the brightness improving film 161 is increased. According to combination of the above advantages, the timepiece display plate 150 can achieve brighter plate surface of the light transmissive dial plate 151.

As a result, in case where various types of color are used for light transmissive dial plate 151, slight difference between different colors can be distinguished, and it is possible to use slightly different colors or tones for the light transmissive dial plate 151.

Furthermore, in the timepiece display plate 150 of the present embodiment, the brightness improving film 161 and the light transmissive dial plate 151, which is a dial plate, that is a face of a timepiece are separately provided. Accordingly, when providing decoration on the light transmissive dial plate 151 by processing such as drilling small holes for attachment of composition, attachment of composition (time characters, letters) into the small holes, forming a brand name, logos, cuttings, and the like by various type of printing (pad printing, screen printing, offset printing, and the like), or other printing or painting, parts on the brightness improving film 161, which functions of improving brightness (for example, prism surfaces 164) can be prevented from being damaged due to separated arrangement of the light transmissive dial plate 151 and the brightness improving film 161.

Accordingly, processing methods of the light transmissive dial plate 151 are not restricted in relation to the brightness improving film 161, and further variation in decorative expressions or processing methods can be used to provide a dial plate with various types of expressions.

Since the front surface 152 and the back surface 153 of the light transmissive dial plate 151 can be provided with decoration, visually stereoscopic expression can be provided and therefore design variation can be expanded.

Moreover, since both of the light transmissive dial plate 151 and the brightness improving film 161 have transmissive properties for visible light, both of the front surface 152 and the back surface 153 of the light transmissive dial plate 151, and both of the front surface 162 and the back surface 163 of the brightness improving film 161 can be provided with decoration which is visible from outside of the timepiece display plate 150. Therefore each surface can have decoration of complicated expression such as decoration with different decorative on each surface.

### Modified Example 1

The timepiece display plate 150 of the above described embodiment has the prism surfaces 164 of the brightness improving film 160, which are disposed to face the solar cell 130 (the back surface 163 is formed with the prism surfaces 164). However, the timepiece display plate according to the present invention is not limited thereto. As shown in FIG. 4, the prism surfaces 164 of the brightness improving film 161 may be disposed to face the light transmissive dial plate 151 (the front surface 162 is formed with the prism surfaces 164).

According to the timepiece display plate 150 of the embodiment (modified example 1) configured as described above, effects similar to those of the timepiece display plate 150 (FIG. 2) of the above described embodiment can be obtained.

That is, a large part of the light entering the front surface 162 of the brightness improving film 161 from outside of the light transmissive dial plate 151 (from a glass side of the timepiece 200) is reflected on the prism surfaces 164 and returns the light transmissive dial plate 151. Thereby, the brightness of the light transmissive dial plate 151 can be improved.

At this time, it is difficult for light input from the light transmissive dial plate 151 to achieve total reflection on the prism surface 164 of the brightness improving film 161 and therefore a less metal texture is obtained. However, since the reflection on the prism surfaces 164 is larger than reflection on a flat surface, the amount of the reflection light returning the light transmissive dial plate 151 is increased so that the brightness (for example, brightness such as whiteness) can be improved.

The effects achieved by the modified example 1 are the same as those achieved by the above described embodiment.

There is a case where the brightness improving film 161 is set with different states in which transmissivities of the light passing from a side of the light transmissive dial plate 151 toward the solar cell 130 are different from each other: a state where the prism surfaces 164 (convexo-concave surface) are disposed to face the light transmissive dial plate 151 (state shown in FIG. 4), and another state where the prism surfaces 164 are disposed to face the solar cell 130 (state shown in FIG. 2). In this case, difference in a light amount of the reflection light toward an observer occurs between the timepiece display plate 150 (FIG. 2) of the above described embodiment and the timepiece display plate 150 (FIG. 4) of the modified example 1, and therefore difference in brightness of the light transmissive dial plate occurs.

Accordingly, with the arrangement where the front surface 162 and the back surface 163 of the brightness improving film 161 are switched when installed in the timepiece 200, the brightness of the light transmissive dial plate 151 can be changed to two different brightness.

Furthermore, according to the timepiece display plate of the modified example 1, there are two states of the prism surfaces 164: a state where the prism surfaces 164 are positioned at a side of the front surface 162 of the brightness improving film 161 and another state where the prism surfaces 164 are positioned at a side of the back surface 163 of the brightness improving film 161. In those two cases, difference in distance from user to the prism surfaces 164 occurs to provide difference in sense of distance (sense of depth) to the user. Difference in a texture can be provided to the user by difference between a case where the reflection light on the prism surfaces 164 to the user is light passing through inside of the brightness improving film 161 (in case of the configuration where the prism surfaces 164 are positioned at a side of the back surface 163 of the brightness improving film 161) and a case where the reflection light on the prism surface 164 is light not passing through inside the brightness improving film 161 (in case of the configuration where the prism surfaces 164 are positioned at a side of the front surface 162 of the brightness improving film 161). Therefore, according to the sense of distance or the texture to be provided to the user, the arranged direction of the prism surfaces 164 of the brightness improving film 161 can be selected.

### Modified Example 2

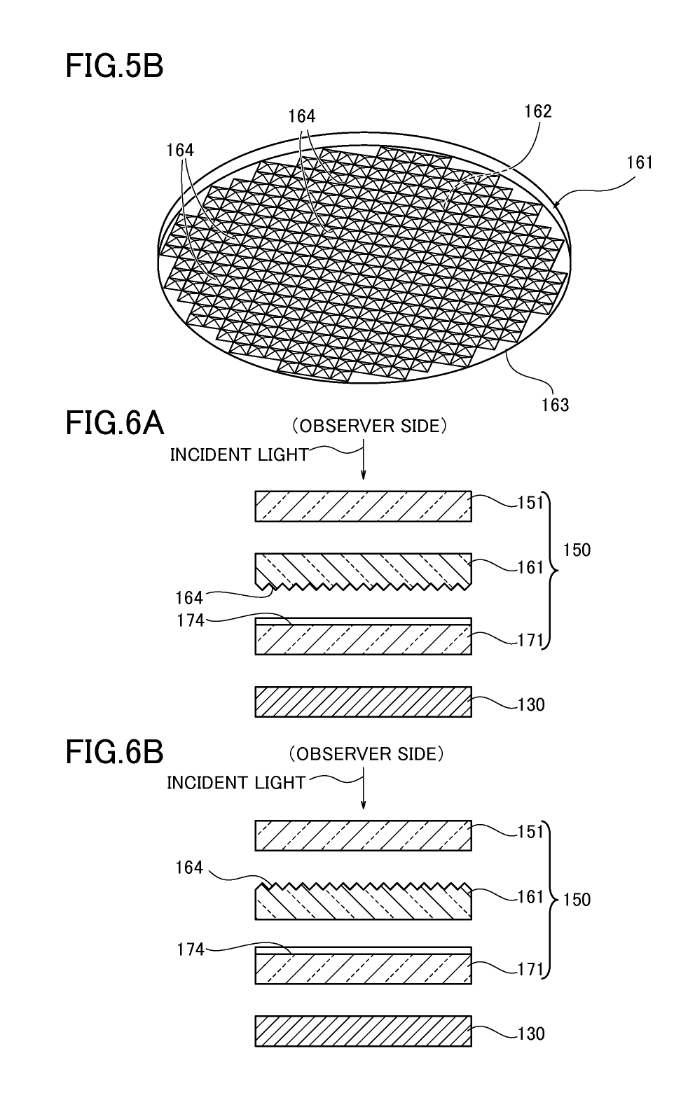

The timepiece display plate 150 of the present embodiment applies a brightness improving film 161 having prism surfaces 164 which extend along one direction to form grooves. However, the timepiece display plate of the present invention is not limited thereto. As shown in FIG. 5, a brightness improving film 161 may be used, in which prism surfaces 164 are regularly arranged along two directions perpendicular to each other in the back surface 163 of the brightness improving film 161 (formed in a geometric pattern (for example, convexo-concave form where four-sided pyramids are regularly arranged in a matrix with closely-attached bases in a grid manner)).

The prism surfaces 164 are formed to extend along one direction in a plate plane of the brightness improving plate (in groove forms extending in one direction). However, in the above described embodiment and the modified example, various types of convexo-concave surface other than prism surfaces can be used in place of the prism surfaces 164.

As the convexo-concave surface, surfaces may be used, which are formed to extend along two directions perpendicular to each other in a plate plane in a regular or random arrangement in a geometric pattern (for example, convexo-concave structure where four-sided pyramid projecting in pyramid shape (FIG. 5A), four-sided pyramid-like concave shape having a convex/concave inverse shape of a four-sided pyramid (FIG. 5B), projecting three-sided pyramid, three-sided pyramid-like concave shape having a convex/concave inverse shape of a three-sided pyramid, a projecting circular cone, a convex/concave inverse shape of a circular cone, projecting semispherical dome-like shape, dome-like concave shape having a convex/concave inverse shape of the above dome like shape, and the like are regularly arranged in a matrix or randomly arranged with closely-attached or adjacent bases to each other). In the following modified examples, the above mentioned various convexo-concave surface can be used in place of prism surfaces.

Furthermore, the timepiece display plate of the present invention may have a brightness improving film 161 where prism surfaces 164 are randomly arranged in the back surface 163 of the brightness improving film 161 (formed in a geometric pattern (for example, formed in a convexo-concave form where four-sided pyramids are randomly arranged)).

In the timepiece display plate 150 of the above described embodiment 1, the prism surfaces 164 of the brightness improving film 161 extends along only one direction. Therefore, when a user obliquely views the timepiece display plate 150 (in a direction at an angle with respect to the front surface 152 of the light transmissive dial plate 151 other than the right angle), difference in the amount of the reflection light from the solar cell 130 is visually recognized by the user between when a viewing direction is in a plane including the extending direction of the prism surfaces 164 and when the viewing direction is not in the plane including the extending direction of the prism surfaces 164.

That is, in case where the brightness improving film 161 is obliquely viewed, when the viewing direction is in the plane including the extending direction of the prism surfaces 164, the amount of the reflection light on the prism surfaces 164 is large and therefore it is relatively brightly visually recognized more than when the viewing direction is not in the plane including the extending direction of the prism surfaces 164.

To the contrary, in the timepiece display plate 150 having the brightness improving film 161 where the prism surfaces 164 are regularly arranged along two directions in the back surface 163 of the brightness improving film 161 or the brightness improving film 161 where the prism surfaces 164 are randomly arranged in the back surface 163 of the brightness improving film 161, regardless of viewing direction of a user, difference in the reflection light amount on the prism surfaces 164 is reduced. Therefore, it is not necessary to take account of a relative direction of the brightness improving film 161 with respect to the light transmissive dial plate 151 (an angle about a rotational center). Accordingly, it is possible to achieve easy assembly of the light transmissive dial plate 151 and the brightness improving film 161.

According to the timepiece display plate 150 of the embodiment (modified example 2) configured as described above, effects similar to those of the timepiece display plate 150 (FIG. 2) of the above described embodiment can be obtained.

### Modified Example 3

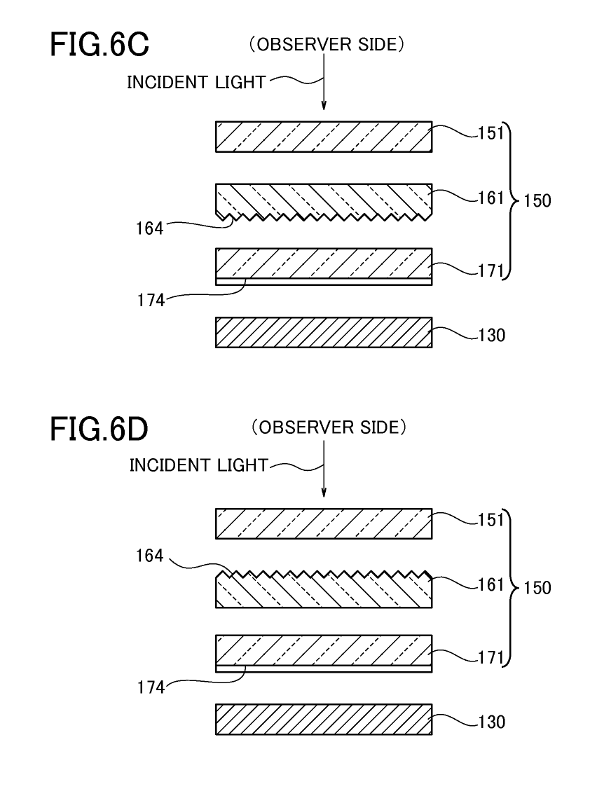

In the timepiece display plate 150 (embodiments in FIG. 2 or FIG. 4) using the brightness improving film 161 where the prism surfaces 164 are formed in groove forms extending along one direction, as shown in FIGS. 6A, 6B, 6C or 6D, between the brightness improving film (first brightness improving film) 161 and the solar cell 130, another brightness improving film (second brightness improving film) 171 is further provided. Here, extending directions of prism surfaces 164, 174 which are respectively formed in the first and second brightness improving films 161, 171 may be perpendicular to each other in a projected state along an overlapped direction of the brightness improving films 161, 171.

That is, in FIG. 6, the prism surfaces 164 of the first brightness improving film 161 are formed to extend in a depth direction of a plane of the sheet, and on the other hand, the prism surfaces 174 of the second brightness improving film 171 are formed to extend in a width direction along the plane of the sheet.

Furthermore, in the configuration of FIG. 6A, the prism surfaces 164 of the first brightness improving film 161 and the prism surfaces 174 of the second brightness improving film 171 are arranged to face each other.

The second brightness improving film 171 has the prism surfaces 174 with different extending direction, and otherwise has the same configuration as the first brightness improving film 161.

As described above, according to the timepiece display plate 150 having two brightness improving films 161, 171 where the prism surfaces 164, 174 extend in directions perpendicularly to each other, in case where a user obliquely views the timepiece display plate 150 (in a direction at an angle other than the right angle with respect to the front surface 152 of the light transmissive dial plate 151), even when the viewing direction is in a plane including the extending direction of one of the prism surfaces 164 (or prism surfaces 174), the viewing direction is not in a plane including the extending direction of the other one of the prism surfaces 174 (or prism surfaces 164). Accordingly, the difference in the reflection light amount on the solar cell 130 is not visually recognized by the user.

That is, due to combination of the two brightness improving films 161, 171, effects similar to those of the one brightness improving film 161 shown in FIG. 5 as the modified example 2 (the prism surfaces 164 are regularly arranged along two directions perpendicular to each other in the back surface 163) are obtained.

For a manufacture of the brightness improving film 161 where the prism surfaces 164 are regularly arranged along two directions perpendicular to each other in the above described modified example 2, very high and accurate manufacturing technology is required and high manufacturing cost, which is more expensive than cost when manufacturing two brightness improving films 161 where the prism surfaces 164 are formed to extend along only one direction is required.

Accordingly, in place of one expensive brightness improving film 161 (modified example 2 of FIG. 5), by combining two relatively inexpensive brightness improving films 161 (embodiment of FIG. 2 or modified example 1 of FIG. 4), occurrence of difference in brightness of the reflection in accordance with the viewing direction can be prevented and total cost of the timepiece display plate 150 can be reduced.

Moreover, due to the configuration where two brightness improving films 161, 171 are arranged in an overlapped manner, the reflection light amount can be increased compared to the timepiece display plate 150 of the above described embodiment using a single brightness improving film 161. Therefore, the further brighter light transmissive dial plate 151 can be provided.

Due to the timepiece display plate 150 of the embodiment (modified example 3) configured as described above, effects similar to that of the timepiece display plate 150 of the above described embodiment (FIG. 2) can be obtained.

Furthermore, the timepiece display plate 150 of the above described embodiment (modified example 3) may have one of the following arrangements: an arrangement in a state where the prism surfaces 164 of the first brightness improving film 161 are formed on a surface at a side close to the solar cell 130 and the prism surfaces 174 of the second brightness improving film 171 are formed on a surface at a side close to the light transmissive dial plate 151 (FIG. 6A); an arrangement in a state where the prism surfaces 164 of the first brightness improving film 161 are formed on a surface at a side close to the light transmissive dial plate 151 and the prism surfaces 174 of the second brightness improving film 171 are formed on a surface at a side close to the light transmissive dial plate 151 (FIG. 6B); an arrangement in a state where the prism surfaces 164 of the first brightness improving film 161 are formed on a surface at a side close to the solar cell 130 and the prism surfaces 174 of the second brightness improving film 171 are formed on a surface at a side close to the solar cell 130 (FIG. 6C); and an arrangement in a state where the prism surfaces 164 of the first brightness improving film 161 are formed on a surface at a side close to the light transmissive dial plate 151 and the prism surfaces 174 of the second brightness improving film 171 are formed on a surface at a side close to the solar cell 130 (FIG. 6D).

Furthermore, the configuration where arbitral one arrangement of the combination is selectable from the four arrangements may be used. By changing arrangement of combination of each of prism surfaces 164, 174 of two brightness improving films 161, 171, degree of the reflection can be easily switched. Therefore, degrees of transparency of the solar cell 130 can be easily switched and thereby the brightness of the light transmissive dial plate 151 can be easily switched.

Moreover, if degree of the reflection is increased, the light transmissive dial plate 151 is brighter and shows more strongly a metal texture and provides luxurious appearance. On the other hand, if degree of the reflection is low, while a metal texture is reduced, transparency is increased. Therefore, by using configuration where a color semitransparent plate or the like is provided between the brightness improving film 171 and the solar cell 130, the reflection light of the solar cell 130 can be suppressed and color tone of the semitransparent plate can be visually recognized by a user.

Furthermore, expression with depth (sense of depth), which cannot be expressed by only one brightness improving film 161, or with less directional property can be provided.

The combination of prism surfaces 164, 174 two brightness improving films 161, 171 can be used in the following other embodiments.

### Modified Example 4

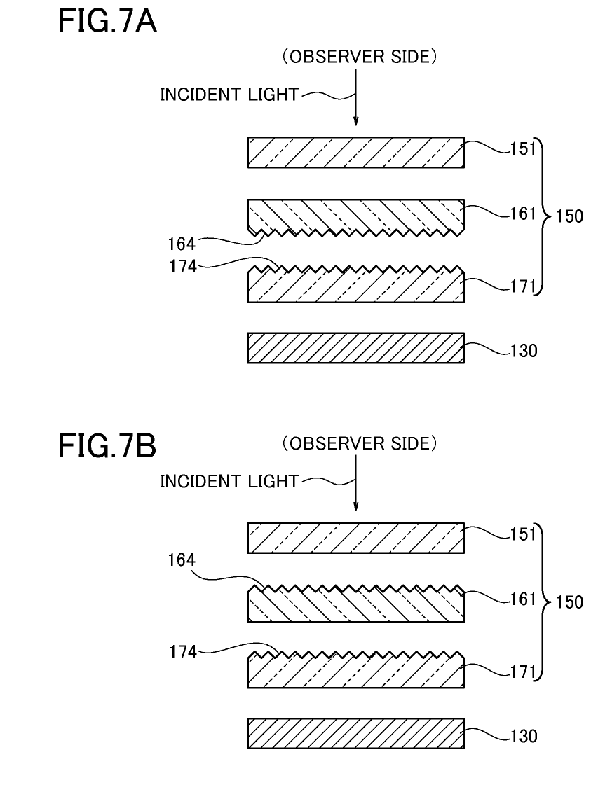

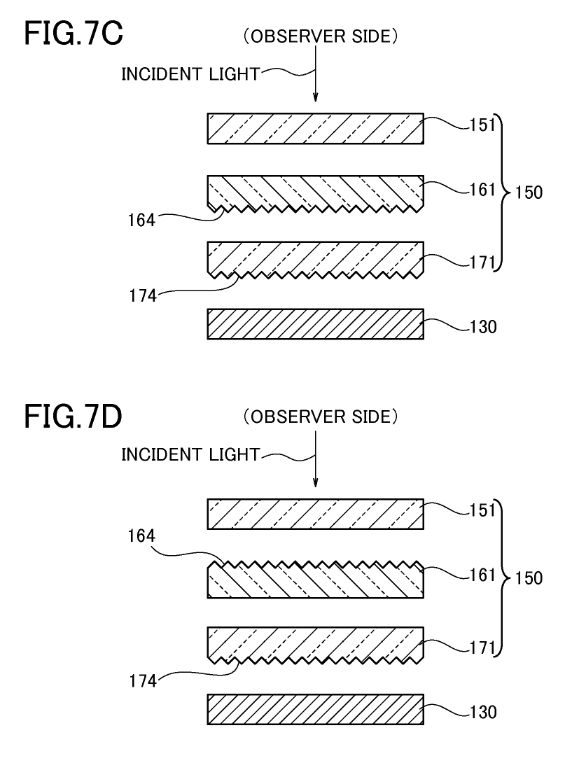

The above described embodiment (modified example 3) has the configuration where the prism surfaces 164 formed in the first brightness improving film 161 and the prism surfaces 174 formed in the second brightness improving film 171 are formed such that the extending directions are perpendicular to each other on a projected plane. However, as shown in FIGS. 7A, 7B, 7C and 7D, a configuration may be used, in which the brightness improving films 161, 171 are arranged such that extending directions of the prism surfaces 164, 174 corresponds to each other (parallel).

As described above, in the timepiece display plate 150 of the embodiment (modified example 4) where two brightness improving films 161, 171 where extending directions of the prism surfaces 164, 174 correspond to each other are arranged in an overlapped manner, occurrence of difference in brightness of the reflection in accordance with viewing directions cannot be prevented as it can be with the timepiece display plate 150 of the modified example 3. However, similarly to the modified example 3, the reflection light amount can be increased compared to the timepiece display plate 150 of the other embodiments using a single brightness improving film 161. Therefore, a further brighter light transmissive dial plate 151 can be provided.

According to the timepiece display plate 150 of the embodiment (modified example 4) configured as described above, effects similar to those of the timepiece display plate 150 (FIG. 2) of the above described embodiment can be obtained.

In the above described timepiece display plate 150 of the modified examples 3, 4, a pattern due to brightness and darkness of light reflected to a side of the light transmissive dial plate 151 may be formed by a through hole penetrating along a thickness direction on at least one of the first brightness improving film 161 and the second brightness improving film 171.

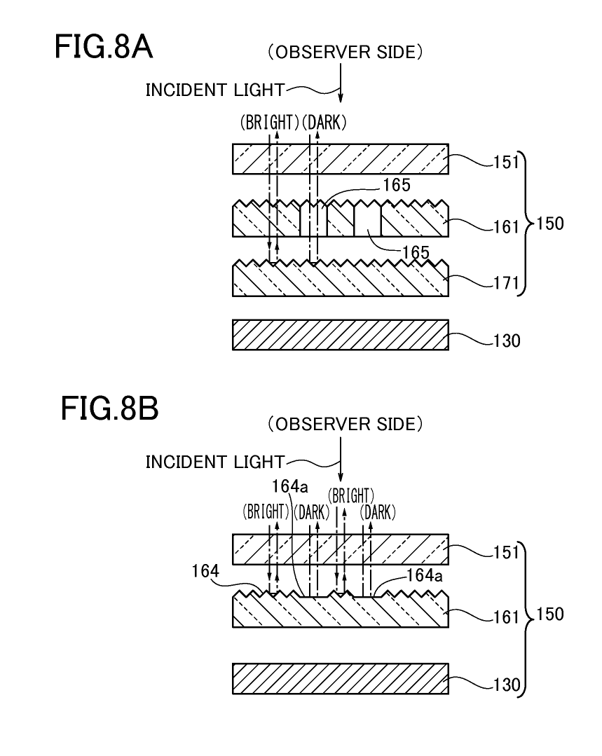

That is, in the timepiece display plate 150 of the modified examples 3, 4, two brightness improving films 161, 171 are overlapped, and thereby brighter reflection light is obtained than the timepiece display plate 150 (embodiment, modified examples 1, 2) having a single brightness improving film 161. For example, as shown in FIG. 8A, if a through hole 165 penetrating in a thickness direction is formed on one of the brightness improving films 161, 171 (for example, the brightness improving film 161), at a part of the through hole, the brightness improving films are not overlapped and light is reflected on only one brightness improving film 171. Therefore, at the part of the through hole 165, substantially same configuration as the timepiece display plate 150 (embodiment, modified examples 1, 2) having only one brightness improving film 161 is provided.

Accordingly, difference in the reflection light amount occurs between the part where the through hole 165 is formed (part where light is reflected on one brightness improving film 171) and a part where the through hole 165 is not formed (part where light is reflected on two brightness improving films 161, 171). Thereby, an observer visually recognizes the part where the through hole 165 is formed relatively darker than the part where the through hole 165 is not formed.

That is, difference in brightness between an inner area (part of the through hole 165) surrounded by an outer circumferential profile of the through hole 165 and an outside area (part out of the through hole 165) of the profile is visually recognized by the observer. Therefore, by forming the profile of the through hole 165 as letters, figures, patterns, and the like, the letters, figures, patterns, and the like can be visually recognized by the observer due to the difference in brightness.

Moreover, in the example of FIG. 8A, the through hole 165 is formed on the first brightness improving film 161 in the timepiece display plate 150 of the embodiment shown in FIG. 7B. However, the configuration where letters, figures, and patterns are visually recognized by formation of the through hole 165 is not limited thereto. A though hole similar to the through hole 165 of the first brightness improving film 161 may be formed on the second brightness improving film 171 in the timepiece display plate 150 of the embodiment shown in FIG. 7B. Otherwise, a through hole similar to the through hole 165 of the first brightness improving film 161 may be formed on the first brightness improving film 161 or the second brightness improving film 171 in the timepiece display plate 150 of the embodiment shown in FIG. 6A, 6B, 6C, or 6D or FIG. 7A, 7C, or 7D.

In this embodiment, as explained in the modified example 3, one of the following arrangements may be used: (1) an arrangement in a state where the prism surfaces 164 of the first brightness improving film 161 are formed on a surface at a side close to the solar cell 130 and the prism surfaces 174 of the second brightness improving film 171 are formed on a surface at a side close to the solar cell (FIG. 7C); (2) an arrangement in a state where the prism surfaces 164 of the first brightness improving film 161 are formed on a surface at a side close to the light transmissive dial plate 151 and the prism surfaces 174 of the second brightness improving film 171 are formed on a surface at a side close to the solar cell 130 (FIG. 7D); (3) an arrangement in a state where the prism surfaces 164 of the first brightness improving film 161 are formed on a surface at a side close to the solar cell 130 and the prism surfaces 174 of the second brightness improving film 171 are formed on a surface at a side close to the light transmissive dial plate 151 (FIG. 7A); and (4) an arrangement in a state where the prism surfaces 164 of the first brightness improving film 161 are formed on a surface at a side close to the light transmissive dial plate 151 and the prism surfaces 174 of the second brightness improving film 171 are formed on a surface at a side close to the light transmissive dial plate 151 (FIG. 7B). A configuration may be used, in which an arbitral one arrangement of combination is selectable from the above four arrangements. By changing arrangement of combination of each of prism surfaces 164, 174 of two brightness improving films 161, 171, degree of the reflection can be easily switched. Therefore, degrees of transparency of the solar cell 130 can be easily switched and thereby the brightness of the light transmissive dial plate 151 can be easily switched.

In the above configuration of each of the arrangements (1) to (4), crossing states of the extending directions of the prism surfaces 164 of the first brightness improving film 161 and the extending directions of the prism surfaces 174 of the second brightness improving film 171 are selectable at an arbitral angle from an angle within a range from 0 degree to 90 degrees in a projected state along the overlapped direction (thickness direction) of the first brightness improving film 161 and the second brightness improving film 171.

As described above, in the configuration where the crossing angle can be arbitrarily selectable, by adjusting the crossing angle, light transmissivity can be changed in accordance with the crossing angle, and the timepiece display plate 150 can have required light transmissivity, reflection ratio, or brightness.

For example, in case of the above arrangement (1), (a) when the crossing angle is 0 degree (extending directions of the prism surfaces 164, 174 are parallel to each other), reflection ratio of light is 30 to 40%, (b) when the crossing angle is 45 degrees, reflection ratio of light is 70 to 85%, (c) when the crossing angle is 67.5 degrees, reflection ratio of light is 70 to 85%, and (d) when the crossing angle is 90 degrees, reflection ratio of light is 70 to 90%.

In case of the above arrangement (3), (a) when the crossing angle is 0 degree (extending directions of the prism surfaces 164, 174 are parallel to each other), reflection ratio of light is 60 to 90%, (b) when the crossing angle is 45 degrees, reflection ratio of light is 50 to 80%, (c) when the crossing angle is 67.5 degrees, reflection ratio of light is 50 to 70%, and (d) when the crossing angle is 90 degrees, reflection ratio of light is 50 to 65%.

Moreover, in the example of FIG. 8A, the through hole 165 is formed on one of two brightness improving films 161, 171 so that letters, figures, and patterns are visually recognized. However, as shown in FIG. 8B, by the timepiece display plate 150 (for example, FIG. 4) with only a single brightness improving film 161, letters, figures, and patterns can be visually recognized similarly to the example shown in FIG. 8A.

That is, in the timepiece display plate 150 shown in FIG. 8B, a part of the prism surfaces 164 is crushed in a shape of letters, figures, and patterns to be visually recognized. The crushed part 164a has less reflection ratio than not crushed parts and therefore due to difference in reflection ratio between the crushed part and the not crushed parts, letters, figures, and patterns can be visually recognized.

In the timepiece display plate 150 shown in FIG. 8B, due to the configuration where the prism surfaces 164 of the brightness improving film 161 are directed to a side of the solar cell 130 (configuration where a part of the prism surfaces 164 is crushed in the timepiece display plate 150 of the embodiment shown in FIG. 2), letters, figures, and patterns can be visually recognized similarly to FIG. 8B.

### Modified Example 5

In the above described timepiece display plate 150 of each embodiment, a configuration having a light trasmissive reflection coating film 180 between the light transmissive dial plate 151 and the brightness improving film 161 can be used as an embodiment of the present invention.

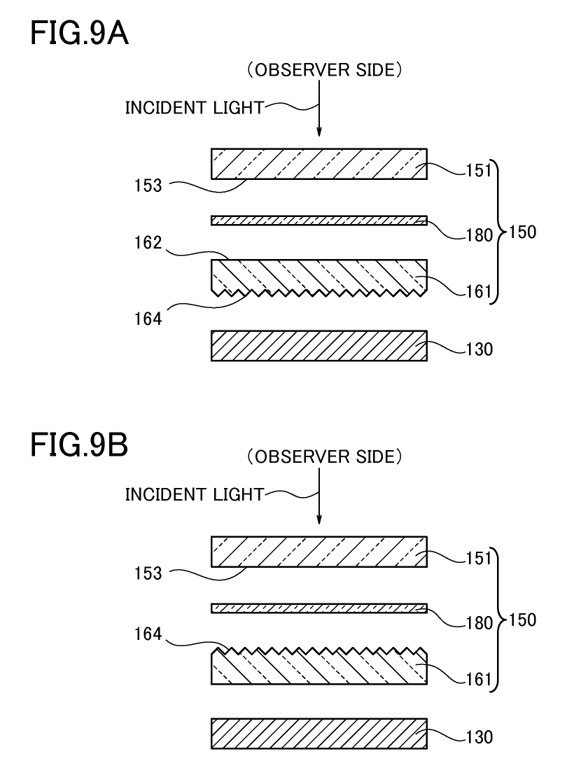

That is, for example, FIG. 9A shows an embodiment of a configuration having a light transmissive reflection coating film 180 between the light transmissive dial plate 151 and the brightness improving film 161 of the timepiece display plate 150 shown in FIG. 2 and FIG. 9B shows an embodiment of a configuration having a light transmissive reflection coating film 180 between the light transmissive dial plate 151 and the brightness improving film 161 of the timepiece display plate 150 shown in FIG. 4.

Here, as the light tansmissive reflection coating film 180, for example, a transparent film (transparent resin film such as urethan resin or epoxy resin) where fine particles of pearl are dispersed can be used. More specifically, the film is not a film body which is separately provided as shown in FIGS. 9A and 9B, and in the configuration shown in FIG. 9A, a film is formed by printing or painting on the back surface 153 of the light transmissive dial plate 151 or the front surface 162 of the brightness improving film 161. In the configuration shown in FIG. 9B, a film is formed by printing or painting on the back surface 153 of the light transmissive dial plate 151.

As objects dispersed in the transparent film, fine particles such as seashell, mica, titanium, alumina, silicon oxide can be used.

According to the timepiece display plate 150 of the embodiment (modified example 5) configured as described above, effects similar to the timepiece display plate 150 of each embodiment without a light transmissive reflection film 180 can be obtained, and light entering the light transmissive reflection film 180 is reflected irregularly with the fine particle of pearl. When the irregularly reflected light is viewed by an observer, brilliancy can be obtained to provide luxurious feeling to the observer.

Furthermore, according to the timepiece display plate having a light transmissive reflection coating film 180 with fine particles such as seashell, mica, titanium, alumina, silicon oxide or the like, effects similar to that of the timepiece display plate 150 having the light transmissive reflection coating film 180 with pearl as dispersed objects can be obtained.

Furthermore, by adjusting an amount, sizes or dispersed degree of the objects to be dispersed in the transparent film, or by adjusting transparency or color of the transparent film itself, an amount of light reaching the brightness improving film 161 from the light transmissive dial plate 151 can be easily adjusted.

### Modified Example 6

In the timepiece display plate 150 of each of the above described embodiments (embodiment, modified examples 1 to 4), the configuration having a light transmissive reflection optical layer 185 between the light transmissive dial plate 151 and the brightness improving film 161 can be used as an embodiment of the present invention.

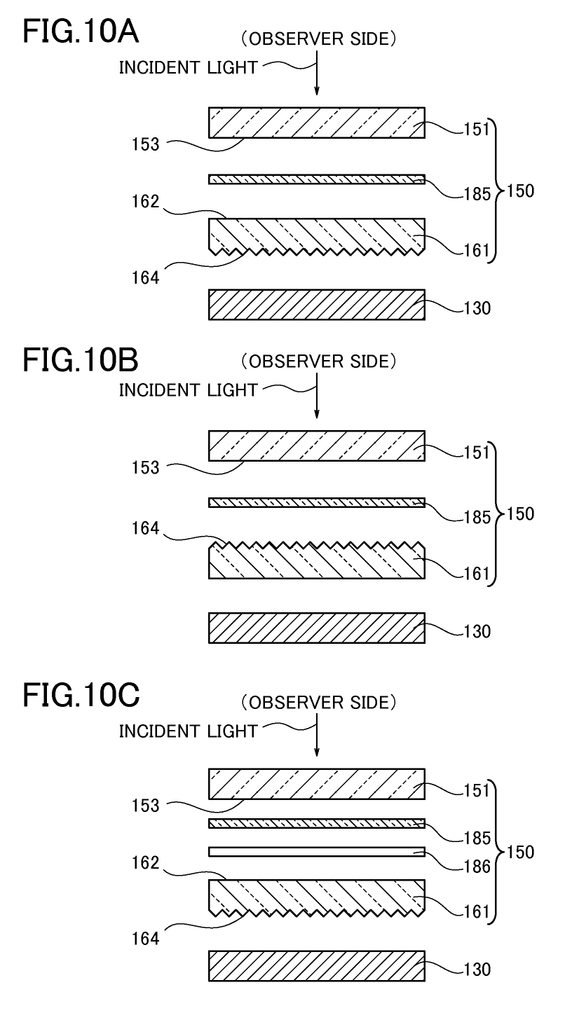

That is, for example, FIG. 10A shows an embodiment of a configuration having a light transmissive reflection optical layer 185 between the light transmissive dial plate 151 and the brightness improving film 161 of the timepiece display plate 150 shown in FIG. 2 and FIG. 10B shows an embodiment of a configuration having a light transmissive reflection optical layer 185 between the light transmissive dial plate 151 and the brightness improving film 161 of the timepiece display plate 150 shown in FIG. 4.

Furthermore, as shown in FIG. 10C, a configuration having a light transmissive reflection optical layer 185 and a decorative layer 186 providing decorative effects between the light transmissive dial plate 151 and the brightness improving film 161 of the timepiece display plate 150 shown in FIG. 2 can be used as an embodiment of the present invention.

Here, as the light tansmissive reflection optical layer 185, for example, a thin film such as titanium oxide (TiO₂), Al₂O₃, silicon oxide (SiO₂), zirconium oxide (ZrO₂), or the like. The reflection ratio and color tone can be freely changed according to thin film design (from transparent film to various color films).

As the reflection optical layer 185, a layer having reflection ratio within a range about from 1% to 50% is used, and in this embodiment, the layer with reflection ratio of about 20% is used.

As the decorative layer 186, for example, a matte film can be used, which is transparent ink (including coating material) where silicon fine particles are added. Furthermore, light transmissive color ink (including coating material) may also be used.

In the embodiment where the decorative layer 186 is added, high degree of freedom in design of brightness and color tone of the timepiece display plate 150 is increased to adapt to various designs. Therefore, brightness or color tone which has not been achieved in the conventional one can be expressed.

At this time, due to thin film designs, not only types of oxide films but also a number of thin film layers (single or multiple layers) can be arbitrarily selectable.

As means for forming the thin film, processing methods such as vapor deposition, sputtering, ion plating and the like can be used.

The light transmissive reflection optical layer 185 of the present embodiment is, for example, a transparent film (total thickness of about 450 to 550 nm) formed by four layers where thin films of zirconium oxide and thin films of silicon oxide are alternately formed, and is a layer body formed by vapor deposition so as to have reflection ratio of about 30%. As shown in FIG. 10A, it may be formed on the back surface 153 of the light transmissive dial plate 151, formed on the front surface 162 of the brightness improving film 161, or separately formed between the light transmissive dial plate 151 and the brightness improving film 161.

Furthermore, the light transmissive reflection optical layer 185 may be, as shown in FIG. 10B, formed on the back surface 153 of the light transmissive dial plate 151, or separately formed between the light transmissive dial plate 151 and the brightness improving film 161.

According to the timepiece display plate 150 of the embodiment (modified example 6) as described above, effects similar to those of the timepiece display plate 150 of each embodiment without the light transmissive reflection optical layer 185 can be obtained. Further, by adjusting film thickness of the reflection optical layer, and the like, an amount of light reaching the brightness improving film 161 from the light transmissive dial plate 151 can be easily adjusted.

Moreover, the light transmissive reflection optical layer 185 can be used in the timepiece display plate 150 having two brightness improving films 161, 171 shown as the modified example 3 or the modified example 4 (FIGS. 6, 7, 8).

That is, it is possible to form the above described light transmissive reflection optical layer 185 on each of or either one of flat surfaces (flat surface where the prism surfaces 164, 174 are not formed) of those two brightness improving films 161, 171. In addition to formation of the light transmissive reflection layer 185 on the flat surface of the brightness improving films 161, 171, or in place of the formation of the light transmissive reflection layer 185 on the flat surface of the brightness improving films 161, 171, the above described light transmissive reflection optical layer 185 can be formed on the back surface 153 of the light transmissive dial plate 151.

### Embodiment of Timepiece

The timepiece 200 as shown in FIG. 1, where the timepiece display plate 150 of the above described embodiment (including each modified examples 1 to 6, the same shall apply hereinafter) is a timepiece using a timepiece display plate according to an embodiment of the present invention. The timepiece 200 also achieves the effects achieved by the embodiment of the timepiece display plate 150.

In the above described embodiment, in case where the amount of the light entering the timepiece display plate 150 is 100%, the solar cell 130 receives the light amount of 10%. The solar cell 130 generates electricity by the received light which provides energy enough to drive the timepiece 200.

Furthermore, the timepiece 200 is a solar timepiece with a solar cell and may be a timepiece (timepiece with a radio-wave correcting function (so-called radio-wave correction timepiece)) having a radio receiving function part to automatically adjust a time to be displayed (including movement of indicators) by receiving a radio wave.

That is, since the timepiece display plate 150 is not made of metal, the timepiece display plate 150 can transmit radio wave. Therefore, when the timepiece 200 is a solar timepiece (with a solar cell) with a radio-wave correcting function, an antenna provided at a lower side of the timepiece display plate 150 can receive the radio wave and automatically adjust time and the like in accordance with the received radio wave.

Accordingly, the timepiece display plate 150 is preferably used in a solar timepiece with a radio-wave correcting function.

It is preferable that surface roughness at a slope part (slope part positioned at both sides across an edge line formed by prism surfaces 164 crossing each other) positioned at both sides of the prism surface 164 of the timepiece display plate 150 in each of the above described embodiments is reduced. In a consideration of cost required for processing, limitation of performance of processing tools, and the like, the surface roughness Ra is preferably within a range of 0.1 to 2.0 μm as an average roughness defined by Japanese Industrial Standards (JIS) B0601.

Furthermore, the surface roughness Ra (JIS B0601) of the slope part is preferably within a range of 0.1 to 1.0 μm, and brightness of the reflection can be increased.

Moreover, when the surface roughness Ra exceeds 2.0 μm, the reflection brightness increasing effect is slightly decreased. However, manufacturing cost can be reduced and a view angle can be expanded.

### CROSS-REFERENCE TO RELATED APPLICATION

The present application claims priority to Japanese Patent Application No. 2010-142503 filed Jun. 23, 2010 to the Japan Patent Office, the entire contents of which are incorporated herein by reference in its entirety.

1. A timepiece display plate for a timepiece having a plate-like solar cell, comprising
a light transmissive dial plate; and
a brightness improving plate disposed between the light transmissive dial plate and the solar cell,
wherein the brightness improving plate has a convexo-concave surface disposed on one of a surface facing the light transmissive dial plate and a surface facing the solar cell, and
wherein the convexo-concave surface is formed by a plurality of arranged prism surfaces.

2. (canceled)

3. (canceled)

4. The timepiece display plate according to claim 3 1,
wherein the brightness improving plate is set to have different light transmissivity of light passing from a side of the light transmissive dial plate toward the solar cell between a state where the prism surfaces are to face the light transmissive dial plate and a state where the prism surfaces is are disposed to face the solar cell.

5. The timepiece display plate according to claim 1,
wherein the prism surfaces are formed to extend along one direction in a plate plane in the brightness improving plate.

6. The timepiece display plate according to claim 1,
wherein the prism surfaces are formed to be regularly arranged along two directions perpendicular to each other in a plate plane in the brightness improving plate or to be randomly arranged in the plate plane.

7. The timepiece display plate according to claim 1, further comprising
a secondary brightness improving plate disposed between the light transmissive dial plate and the brightness improving plate, or between the brightness improving plate and the solar cell.

8. The timepiece display plate according to claim 7,
wherein an arrangement of combination of the prism surfaces of the brightness improving plate and the prism surfaces of the secondary brightness improving plate is selectable among the following arrangements of combination (1) to (4):
(1) an arrangement in a state where the prism surfaces of the brightness improving plate are formed on a surface at a side close to the light transmissive dial plate and the prism surfaces of the secondary brightness improving plate are formed on a surface at a side close to the light transmissive dial plate;
(2) an arrangement in a state where the prism surfaces of the brightness improving plate are formed on the surface at the side close to the light transmissive dial plate and the prism surfaces of the secondary brightness improving plate are formed on a surface at a side close to the solar cell;
(3) an arrangement in a state where the prism surfaces of the brightness improving plate are formed on a surface at a side close to the solar cell and the prism surfaces of the secondary brightness improving plate are formed on the surface at the side close to the light transmissive dial plate; and
(4) an arrangement in a state where the prism surfaces of the brightness improving plate are formed on the surface at the side close to the solar cell and the prism surfaces of the secondary brightness improving plate are formed on the surface at the side close to the solar cell.

9. The timepiece display plate according to claim 7,
wherein the prism surfaces of the brightness improving plate and the prism surfaces of the secondary brightness improving plate are respectively formed to extend along one direction in the plate plane; and
wherein the brightness improving plate and the secondary brightness improving plate are disposed such that an extending direction of the prism surfaces formed on the brightness improving plate and an extending direction of the prism surfaces formed on the secondary brightness improving plate are perpendicular to each other in a projected state along an overlapped direction of the brightness improving plate and the secondary brightness improving plate.

10. The timepiece display plate according to claim 7,
wherein the prism surfaces of the brightness improving plate and the prism surfaces of the secondary brightness improving plate are respectively formed to extend along one direction in the plate plane; and
wherein the brightness improving plate and the secondary brightness improving plate are disposed such that a crossing state of an extending direction of the prism surfaces formed on the brightness improving plate and an extending direction of the prism surfaces formed on the secondary brightness improving plate is selectable at an arbitral angle among an angle range between 0 degree and 90 degrees in a projected state along an overlapped direction of the brightness improving plate and the secondary brightness improving plate.

11. The timepiece display plate according to claim 7,
wherein a pattern is formed by brightness and darkness of light reflected to a side of the light transmissive dial plate by a through hole which is formed on, and penetrates along a thickness direction, at least one of the brightness improving plate and the secondary brightness improving plate.

12. The timepiece display plate according to claim 1,
wherein a surface roughness Ra of slope parts positioned at both sides of the prism surfaces is in a range of 0.1 to 2.0 μm.

13. The timepiece display plate according to claim 1, further comprising
a reflection coating film disposed between the light transmissive dial plate and the brightness improving plate.

14. The timepiece display plate according to claim 1, further comprising
a reflection optical layer disposed between the light transmissive dial plate and the brightness improving plate.

15. The timepiece display plate according to claim 14, further comprising
a decorative layer disposed between the brightness improving plate and the reflection optical layer.

16. The timepiece display plate according to claim 1,
wherein the prism surfaces are formed on the surface of the light transmissive dial plate facing the solar cell.

17. The timepiece display plate according to claim 1,
wherein the prism surfaces are formed to have a spiral form or concentric circle form.
